(19) United States
(12) Patent Application Publication
(10) Pub. No.: US 2011/0137714 A1
(43) Pub. Date: Jun. 9, 2011

(54) SYSTEM FOR MANAGING BUSINESS PERFORMANCE USING INDUSTRY BUSINESS ARCHITECTURE MODELS

(75) Inventors: Muthulakshmi Bhandari, Bangalore (IN); Allison Baines Botros, Independence, OH (US); Edward H B Giesen, Bilthoven (NL); Raman Harishankar, Blacklick, OH (US); Ying Tat Leung, Saratoga, CA (US); Ashish Mungi, Bangalore (IN); Siddharth N. Purohit, Allen, TX (US); Jorge L. C. Sanz, Carmel, CA (US)

(73) Assignee: INTERNATIONAL BUSINESS MACHINES CORPORATION, Armonk, NY (US)

(21) Appl. No.: 12/630,063

(22) Filed: Dec. 3, 2009

(51) Int. Cl. G06Q 10/00

(52) U.S. Cl. 705/7.39; 705/348

(57) ABSTRACT

A system and dashboard are provided for managing business performance. Key performance indicators developed for a component business model map are computed and displayed along with the map in real time. A user may select a corresponding key performance indicator to display a heat map of components on the dashboard.

### CROSS REFERENCE TO RELATED APPLICATIONS

The present invention is related to U.S. application Ser. No. 10/796,367 filed Mar. 9, 2004 titled SERVICES COMPONENT BUSINESS OPERATION METHOD which is incorporated herein in its entirety. This application is also related to U.S. application Ser. No. ______ filed ______ entitled TOOL FOR CREATING AN INDUSTRY BUSINESS ARCHITECTURE MODEL, and U.S. application Ser. No. ______ filed ______ entitled ASSESSING THE MATURITY OF AN INDUSTRY ARCHITECTURE MODEL which are incorporated herein by reference in its entirety.

### BACKGROUND OF THE INVENTION

1. Field of the Invention

The invention relates generally to enterprise architectures. More particularly, the invention relates to a system for managing business performance using an industry business architecture model including but not limited to a component business model.

2. Description of Related Art

Rackham in U.S. application Ser. No. 10/796,367 describes the component business modeling process and elements. In particular Rackham describes a component business modeling map and a process for filtering this map to form a heat map of components.

Bhaskaran in U.S. application Ser. No. 10/692,898 filed Oct. 24, 2003 discloses end-to-end business process solution creation with business measurements and initiatives according to defined business goals and objectives of an entity. Business operations of the entity are modeled in terms of business process elements including process tasks, artifact flows, artifact repositories and business commitment elements including key performance indicators. Bhaskaran's model and process elements may be continuously refined over a solution development lifecycle.

Ang in application Ser. No. 11/496,917 filed Jul. 31, 2006 describes use of key performance indicators for measurement of attainment of goals. Bhaskaran and Ang shall be incorporated herein by reference in their entireties.

### BRIEF SUMMARY OF THE INVENTION

Managing the business performance of a large enterprise is important to maintaining the ongoing health and growth of the enterprise. The management must be performed over an entire life cycle of a typical enterprise in an industry. The balanced scorecard and benchmarking are known techniques used in this area but both have known drawbacks. The balanced scorecard teaches how to select performance measures. Benchmarking helps identify what performance measures can be improved based on peer performance. However, neither technique spans the entire life cycle of selecting performance indicators, to monitoring, to identifying opportunities, to developing solutions, and feedback to selecting new performance indicators. The present invention overcomes this limitation by providing a system and dashboard for managing business performance throughout this life cycle in the manner as will be described below.

### BRIEF DESCRIPTION OF THE SEVERAL VIEWS OF THE DRAWINGS

FIG. 1 shows the life cycle of managing business performance according to the present invention;

FIG. 2 is a block diagram depicting a system in accordance with the present invention;

FIG. 3 shows a representative component business model map; and

FIG. 4 is an example of a heat map

### DETAILED DESCRIPTION OF THE INVENTION

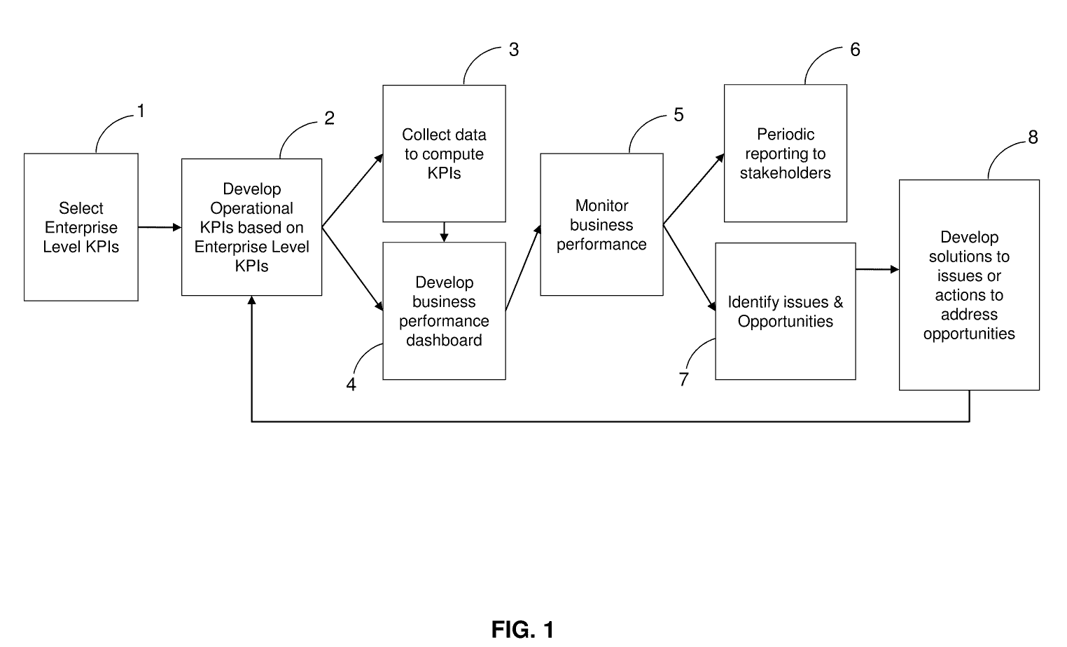

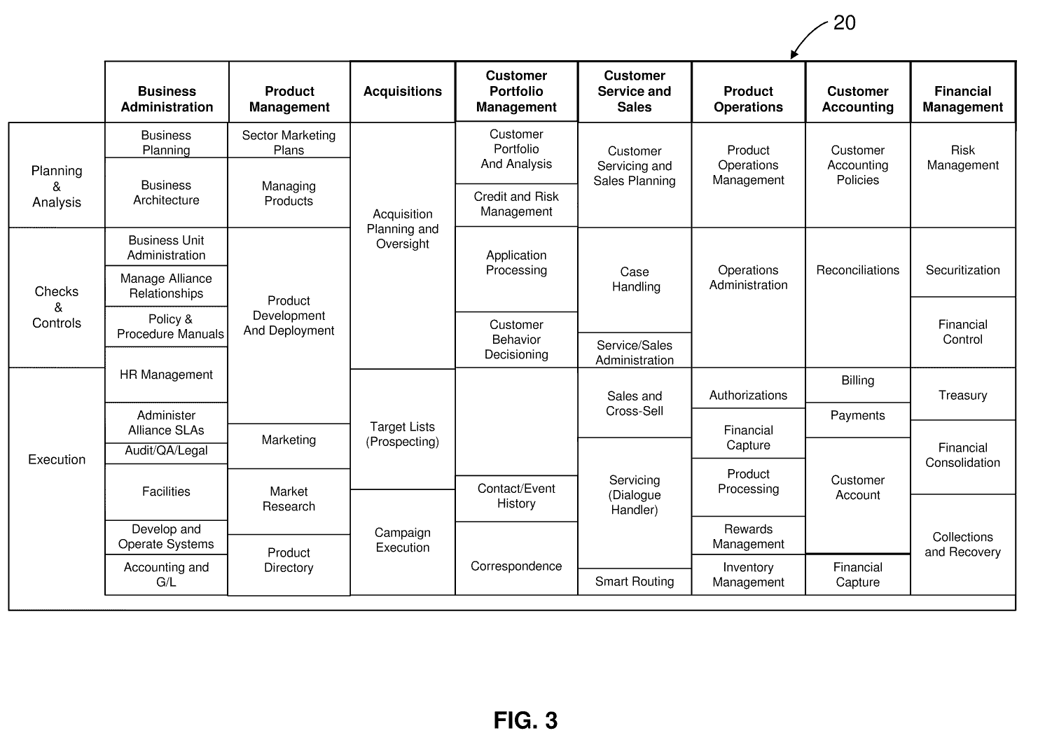

In FIG. 1 there is shown a lifecycle flowchart of business performance management in accordance with the present invention. A component business model map such as described below and shown in FIG. 3 has been previously generated. The techniques of generation are described in application Ser. No. 10/796,367. In step 1 of FIG. 1, Enterprise level key performance indicators (KPIs) are selected.

Key performance indicators, also known as key success indicators or key business indicators are used by businesses to define and measure progress toward their goals. As used herein, KPIs represent quantifiable, measurable objectives, agreed to beforehand, that reflect the critical success factors of an organization. KPIs differ depending on an industry or organization. A sales organization may use the percentage of its sales that come from return customers. A customer service organization may measure the number of customer service calls answered in less than one minute. To determine if the objectives associated with a KPI are being met, the KPI may need to be broken down into one or more metrics, which are specific measurements to collect for analysis. According to the present invention the measurements are collected in real time using data collective apparatus 14 connected to various systems, devices, and terminals located throughout the enterprise.

The KPIs in step 1 are enterprise level KPIs dealing with indicators of progress for the enterprise.

In step 2 of FIG. 1, operational KPIs are developed for each component, based on the enterprise level KPIs.

In step 3 of FIG. 1 data for computing values for the KPIs is collected in real time using data collection apparatus 14 described above.

In step 4, a business performance dashboard is developed specific to the business being analyzed. The system of the present invention includes a dashboard developing capability wherein the dashboard displays a component business model map such as the example shown in FIG. 3. The map has been developed using an industry business architecture model. The map has business processes, the enterprise key performance indicators and attributes.

The map also has the operational key performance indicators described above and the computed real time values thereof.

The system and dashboard of the present invention are constructed in such a manner that a user can select an enterprise key performance indicator whereupon the dashboard displays a heat map corresponding thereto.

The system and dashboard may also be used to display an enterprise key performance tree. The tree may be developed using a casual model approach.

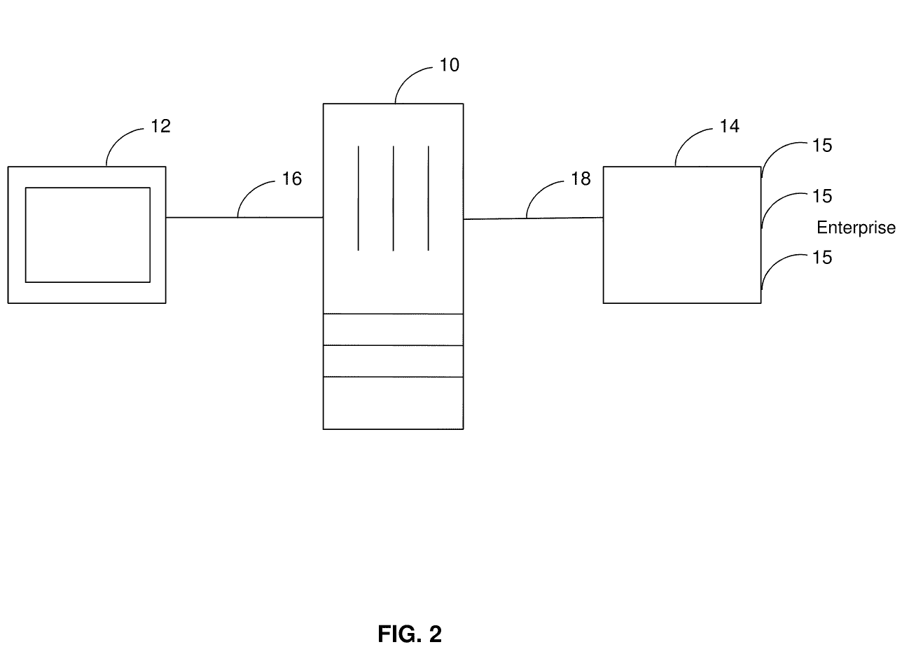

In step 5, business performance is monitored in real time using server 10, display 12, and data collection apparatus 14 of FIG. 2. Display 12 shows the dashboard as just described. By monitoring business performance in this manner using the system and dashboard of the present invention, reports can be periodically made to stakeholders in step 6. In addition, issues and opportunities can be identified 7 from the monitored performance of step 5.

Finally in step 8 of the lifecycle flow chart of FIG. 1, solutions are developed for the issues identified in step 7. Furthermore, actions are also taken to address the opportunities identified in step 7.

As such solutions and actions are implemented, a natural feedback path is taken back to step 2 where new or updated operational KPIs based on the enterprise level KPIs may be developed.

FIG. 2 shows a system suitable for implementing an embodiment of the present invention. Server 10 is operably connected to display device 12 over connection 16. Server 10 is also operably connected to data collection apparatus 14 over connection 18. Server 10 may be any type of computing system known in the art capable of executing instructions for implementing necessary steps of the embodiment. Typically server 10 may include a processing unit, I/O interface, network adaptor and memory.

Connections 16 and 18 may be any type of connection known in the art for transferring data such as a bus, network, wireless, infrared, or the like. Display device 12 includes a viewing screen but may also include processing hardware and software. Indeed, display device may comprise a workstation, laptop, personal digital assistant, cell phone, or any device having a display screen.

Data collection apparatus 14 includes connections 15 to various systems, devices, and terminals (not shown) located within an enterprise for gathering data necessary for calculating key performance indicator values in real time.

In FIG. 3 there is shown an example of component business model map 20 in accordance with the present invention. The map is a matrix of activities having rows and columns. The rows of matrix 20 are grouped into three management levels of business activities, namely, planning and analysis, checks and controls, and execution. The rows of the matrix are standard for all industries, defining three levels of management control. For each grouping of activities in a column, a combination of these three levels is usually required to ensure the business operates effectively.

The columns of matrix 20 are activity categories which are industry specific. However, once a good component map is built for any client, it may be used for any other client or competency in that specific industry. Business activities are determined in interviews supported by subject area specialists to identify both current and future capabilities. Activities may be specified in the general terms of: Functionality—the Subject; Users—Skill level, authority; Systems; Analytical; Operational, decisioning; Automated; Operational Characteristics; Business information usage; or any other general terms used in the industry.

Components within the activity categories should be able to be extracted (e.g. subcontracted) without disrupting the enterprise. Smart components may be defined and represent opportunities for development by the services providing company. A component map, when built, depicts the future enterprise and industry leading practices. The level of detail is appropriate for the required analysis (is retractable and expandable). Activities are performed only in one component.

Within each component, enterprise level key performance indicators are selected (FIG. 1, step 1) as described above.

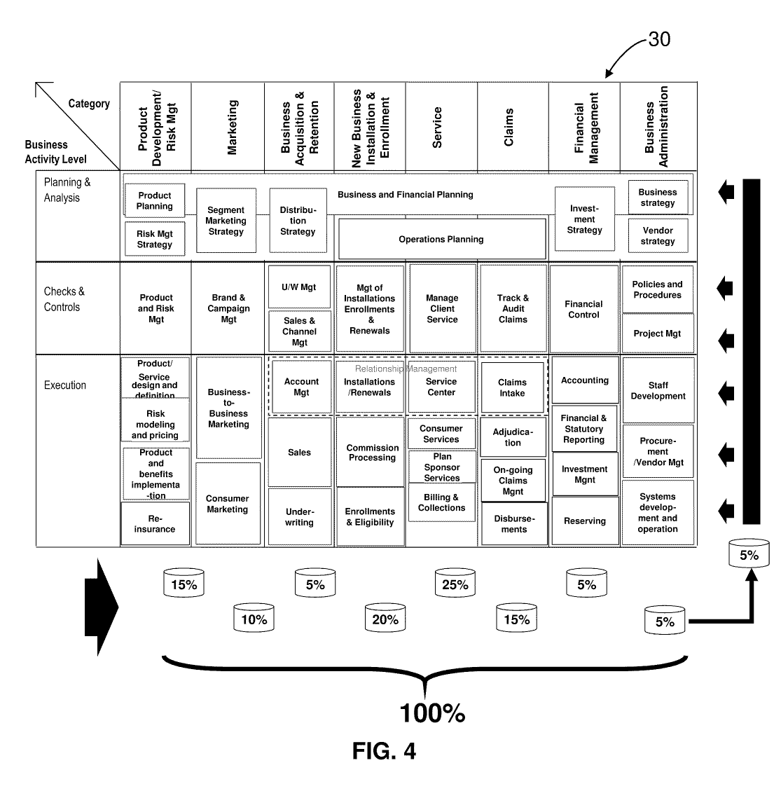

In FIG. 4 there is shown an example of a heat map in accordance with the present invention. The component map in FIG. 3 is filtered to form a heat map. For each activity category in component map 20, capabilities are defined that summarize how the enterprise seeks to perform in that aspect of its business. Target competitive levels are then determined for each capability. Competitive levels may then be used to filter component map 20.

Cost filtering may also be performed. For example, in FIG. 4, 15% of cost is allocated to the Product Development/Risk Management activity category. The allocation may be based on cost center data which may be collected in real time by apparatus 14. Any other basis of allocating cost may be used such as by the number of full time equivalent (FTE) people required to perform the activities involved. For each column, the allocated cost is then distributed across components in that column on another basis, for example, headcount. In FIG. 4 the 5% allocated to Business Administration is distributed across the components in the last column by headcount.

Revenue filtering may be performed using similar allocation and distribution methods.

The results of filtering are summarized on the component map of FIG. 3 such as by indicating the competitive level, cost level, or revenue level for each component.

After applying the filtering just described, components are selected to form a heat map. Selected components should be components that drive the primary strategy of the company such as low cost provider, brand, servicing, and also have a large gap between the current and desired capabilities. Components that have a large potential to increase revenue or reduce cost may also be selected. Components that the client or interviewer have identified as problematic may be selected. Components required to perform key functions may also be selected.

A component map having only the selected components shall be designated herein to be a heat map.

While there have been shown and described what are at present considered the preferred embodiments of the invention, it will be obvious to those skilled in the art that various changes and modification may be made therein without departing from the scope of the invention as defined by the appended claims.

What is claimed is:

1. A business performance dashboard, comprising:
a component business model map of components for an enterprise, said map having been developed using an industry business architecture model and having business processes, enterprise key performance indicators, and attributes;
operational key performance indicators based on said enterprise key performance indicators;
an automatic data collection apparatus for calculating said enterprise and said operational key performance indicators; and
a real time dashboard having a user interface comprising said component business model map and said enterprise key performance indicators.

2. The dashboard of claim 1, wherein said dashboard is adapted to show a heat map from said component business model map in response to selection of a corresponding enterprise key performance indicator.

3. The dashboard of claim 1, further comprising an enterprise key performance indicator tree.

4. The dashboard of claim 3, wherein said enterprise key performance indicator tree is developed using a causal model approach.

5. A system for managing business performance using an industry business architecture model, comprising:
a server operably coupled to display apparatus, said display apparatus having a real time dashboard user interface;
a component business model map of components for an enterprise, said map having been developed using an industry business architecture model, wherein said component business model map has business processes, enterprise key performance indicators, and attributes;
operational key performance indicators based on said enterprise key performance indicators;
an automatic data collection apparatus operably coupled to said server, for gathering business data, including values for said attributes, in real time and therefrom calculating performance indicators; and
a real time display on said display apparatus including said component business model map, said dashboard, and said values for said enterprise and said operational key performance indicators.

6. The system of claim 5, wherein said dashboard is adapted to show a heat map from said component business model map in response to selection of a corresponding enterprise key performance indicator.

7. The system of claim 5, further comprising an enterprise key performance indicator tree.

8. The system of claim 7, wherein said enterprise key performance indicator tree is developed using a casual model approach.

9. A storage medium encoded with machine-readable computer program code for managing business performance using an industry business architecture model, over a network to implement a method, comprising:
displaying a real time dashboard on a display device operably coupled to said network;
displaying on said device a component business model map of components for an enterprise, said map having been developed using an industry business architecture model, wherein said component business model map has business processes, enterprise key performance indicators, and attributes;
displaying on said device operational key performance indicators based on said enterprise key performance indicators;
using an automatic data collection apparatus operably coupled to said network, for gathering business data, including values for said attributes, in real time and therefrom calculating performance indicators; and
displaying on said display device said component business model map, said dashboard, and said values for said enterprise and said operational key performance indicators.

10. The storage medium of claim 9, further comprising instructions for causing said network to implement said dashboard wherein said dashboard is adapted to show a heat map from said component business model map in response to selection of a corresponding key performance indicator.
